(19) United States
(12) Patent Application Publication
(10) Pub. No.: US 2005/0035814 A1
(43) Pub. Date: Feb. 17, 2005

(54) Precise voltage/current reference circuit using current-mode technique in CMOS technology

(75) Inventors: Qing Ou-yang, Shanghai (CN); Howard Yang, Shanghai (CN); YuFei Gu, Shanghai (CN)

Correspondence Address: BEVER, HOFFMAN & HARMS, LLP, 1432 CONCANNON BLVD, BUILDING G, LIVERMORE, CA, 94550-6006, US

(73) Assignee: Integrated Device Technology, Inc., Santa Clara, CA (US)

(21) Appl. No.: 10/832,986

(22) Filed: Apr. 26, 2004

(30) Foreign Application Priority Data
Aug. 15, 2003 (CN) 03154092.9

(51) Int. Cl. G05F 1/10

(52) U.S. Cl. 327/541

(57) ABSTRACT

A voltage/current reference circuit includes a first bipolar transistor and a second bipolar transistor that exhibit a first voltage drop V_{BE1} and a second voltage drop V_{BE2}, respectively. A first resistor, having a resistance R1, is configured to draw a first current equal to (V_{BE1}−V_{BE2})/R1. A second resistor, having a resistance R2, is configured to draw a second current equal to V_{BE1}/R2. A first transistor supplies the first and second currents to the first and second resistors. A second transistor, having a current mirror configuration with respect to the first transistor, directly provides a reference current equal to (V_{BE1}−V_{BE2})/R1+V_{BE1}/R2. A third transistor, having a current mirror configuration with respect to the first transistor, provides a current equal to the reference current to a third resistor having a resistance R3 and a third bipolar transistor that exhibits a third voltage drop V_{BE3}, thereby generating a reference voltage.

### FIELD OF THE INVENTION

The present invention relates to a precise voltage/current reference circuit that is insensitive to variations in temperature and power supply voltage. More specifically, the present invention relates to a voltage/current reference circuit using a current-mode technique in CMOS technology.

### RELATED ART

FIG. 1 is a circuit diagram of a conventional on-chip bandgap voltage reference circuit 100 used in CMOS analog/mixed signal chips. Voltage reference circuit 100 includes PMOS transistors 101-102, operational amplifier 105, resistors 111-113 and PNP bipolar transistors 121-122, which are connected as illustrated. Resistors 111, 112 and 113 have resistances of R1, R2 and R3, respectively. The input voltages to the “+” and “−” input terminals of operational amplifier 105 are labeled as input voltages V+ and V−, respectively. The base-to-emitter voltage of bipolar transistor 121 is designated V_{BE1}, and the base-to-emitter voltage of bipolar transistor 122 is designated V_{BE2}. The input voltage V− is therefore equal to V_{BE1}. The input voltages V+ and V− are forced to be equal, such that the input voltage V+ is also equal to V_{BE1}.

The voltage across resistor 113, designated as ΔV_{BE}, can therefore be defined as follows.
ΔV_{BE}=V_{BE1}−V_{BE2} (1)

The current I₁₁₃ through resistor 113 can then be defined as follows.
I₁₁₃=ΔV_{BE}/R3 (2)

The voltage drop across resistor 112, (i.e., V₁₁₂), can therefore be defined as follows.
V₁₁₂=I₁₁₃×R2=ΔV_{BE}×R2/R3 (3)

Thus, the reference voltage V_{REF1} can be defined as follows.
V_{REF1}=V_{BE1}+ΔV_{BE}×R2/R3 (4)

The voltage ΔV_{BE} is proportional to the threshold voltage V_{T}. The voltage V_{BE1} has a negative temperature coefficient of about −2 mV/° C., whereas V_{T} has a positive temperature coefficient of 0.086 mV/° C. As a result, the temperature variation of V_{REF1} can be compensated by the ratio of R2/R3.

FIG. 2 is a circuit diagram of another conventional on-chip bandgap voltage reference circuit 200 used in CMOS analog/mixed signal chips. Voltage reference circuit 200 includes PMOS transistors 201-203, operational amplifier 205, resistors 211-214 and PNP bipolar transistors 221-222, which are connected as illustrated. PMOS transistors 201-203 are all the same size. The currents through PMOS transistors 201, 202 and 203 are designated as I₁, I₂ and I₃, respectively. Resistors 211, 212, 213 and 214 have resistances of R1, R2, R3 and R4, respectively. Resistance R1 is equal to resistance R2. The input voltages to the “+” and “−” input terminals of operational amplifier 205 are labeled as input voltages V+ and V−, respectively. The base-to-emitter voltage of bipolar transistor 221 is designated V_{BE1}, and the base-to-emitter voltage of bipolar transistor 222 is designated V_{BE2}. The input voltage V− is therefore equal to V_{BE1}. Operational amplifier 205 forces the input voltages V+ and V− to be equal, such that the input voltage V+ is also equal to V_{BE1}.

Because PMOS transistors 201-203 are identical, and R1 is equal to R2, the currents I₁, I₂ and I₃ are equal to one another.
I₁=I₂=I₃ (5)

Because the voltage V+ is equal to the voltage V−, the current through resistor 211 (i.e., I_{1B}) is equal to the current through resistor 212 (i.e., I_{2B}).
I_{1B}=I_{2B} (6)

As a result, the current through bipolar transistor 221 (i.e., I_{1A}) is equal to the current through resistor 213 and bipolar transistor 222 (i.e., I_{2A})
I_{1A}=I_{2A} (7)

The current I_{2A} through resistor 213 can be defined as follows. This current I_{2A} is proportional to the threshold voltage V_{T}.
I_{2A}=ΔV_{BE}/R3 (8)

The current I_{2B} through resistor 212 can be defined as follows. This current I_{2B} is proportional to V_{BE1}.
I_{2B}=V_{BE1}/R2 (9)
Current I₃ can therefore be defined as follows.
I₃=I₂=I_{2A}+I_{2B} (10)

As a result, the output reference voltage V_{REF2}, which is equal to the current I₃×R4, can be defined as follows.
V_{REF2}=R4×(ΔV_{BE}/R3+V_{BE1}/R2) (11)

As described above, the voltage ΔV_{BE} is proportional to the threshold voltage V_{T}, which has a positive temperature coefficient of 0.086 mV/° C., and the voltage V_{BE1} has a negative temperature coefficient of about −2 mV/° C. Thus, the temperature variation of V_{REF2} can be compensated by the resistance ratio R2, R3 and R4.

FIG. 3 is a graph 300 that illustrates a simulated DC voltage sweep from 0 Volts to 3 Volts on the gates of transistors 201-203 (line 301), and the resultant output voltage of operational amplifier 205 (line 302). In this simulation, the output terminal of operational amplifier 205 is disconnected from the gates of PMOS transistors 201-203. Graph 300 illustrates that there are three cross-points, A, B and C, where the output of operational amplifier 205 is equal to the voltage applied to the gates of transistors 201-203. Thus, there are three possible steady state operating conditions for reference circuit 200. However, only one of these operating conditions (cross-point A) represents the desired operating conditions of the reference circuit 200. Reference circuit 200 may or may not end up in the desired operating state, depending upon the mismatch between the currents I₁, and I₂ or the resistances R1 and R2.

Moreover, as described above, reference circuits 100 and 200 are both voltage references. If a current reference is needed, a voltage-to-current conversion circuit is typically used, wherein the reference voltage is applied to a resistor, thereby creating an associated reference current I_{REF}. However, such a resistor has a positive temperature coefficient. Thus, while the reference voltage may be temperature insensitive, the reference current will vary with variations in temperature, due to the temperature dependence of the resistor. The process variation of the resistor is a major factor that degrades the precision of the current reference.

It would therefore be desirable to have a reference circuit capable of generating both a reference voltage and a reference current that are insensitive to variations in both temperature and power supply voltage. It would further be desirable for this reference circuit to have a single steady-state operating point.

### SUMMARY

Accordingly, the present invention provides a reference circuit that includes a first bipolar transistor that exhibits a first base-to-emitter voltage V_{BE1}, and a second bipolar transistor that exhibits a second base-to-emitter voltage V_{BE2}, wherein V_{BE1} is greater than V_{BE2}. The voltage V_{BE1} is applied to a one terminal of a first resistor, and the voltage V_{BE2} is applied to the other terminal of the first resistor, such that a voltage of V_{BE1}−V_{BE2} is applied across the first resistor. The first resistor has a resistance R1, such that a first current equal to (V_{BE1}−V_{BE2})/R1 flows through this first resistor.

In addition, the voltage V_{BE1} is applied across a second resistor. The second resistor has a resistance R2, such that a second current equal to V_{BE1}/R2 flows through this second resistor.

A first MOS transistor is configured to supply the first and second currents to the first and second resistors. As a result, the first MOS transistor carries a current equal to the sum of the first and second currents, or (V_{BE1}−V_{BE2})/R1+V_{BE1}/R2. A second MOS transistor, having a current mirror configuration with respect to the first transistor, directly provides a reference current equal to (V_{BE1}−V_{BE2})/R1 +V_{BE1}/R2. By properly selecting the ratio of resistances R1 and R2, the reference current can be made insensitive to variations in temperature and power supply voltage.

A third transistor, having a current mirror configuration with respect to the first transistor, provides a current equal to the reference current (i.e., (V_{BE1}−V_{BE2})/R1 +V_{BE1}/R2) to a third resistor having a resistance R3. This third resistor is connected in series with a third bipolar transistor that exhibits a third base-to-emitter voltage V_{BE3}. As a result, the voltage drop across the third resistor and the third bipolar transistor is equal to V_{BE3}+(R3×(V_{BE1}−V_{BE2})/R1+R3×V_{BE1}/R2). This voltage drop is used as a reference voltage. By properly selecting the ratio of the resistances R1, R2 and R3, the reference voltage can be made insensitive to variations in temperature and power supply voltage. Moreover, by properly selecting the ratio of the resistances R1, R2 and R3, the voltage and current reference circuit can be controlled to have a single steady-state operating point.

The present invention will be more fully understood in view of the following description and drawings.

### BRIEF DESCRIPTION OF THE DRAWINGS

FIG. 1 is a circuit diagram of a conventional on-chip bandgap voltage reference circuit used in CMOS analog/mixed signal chips.

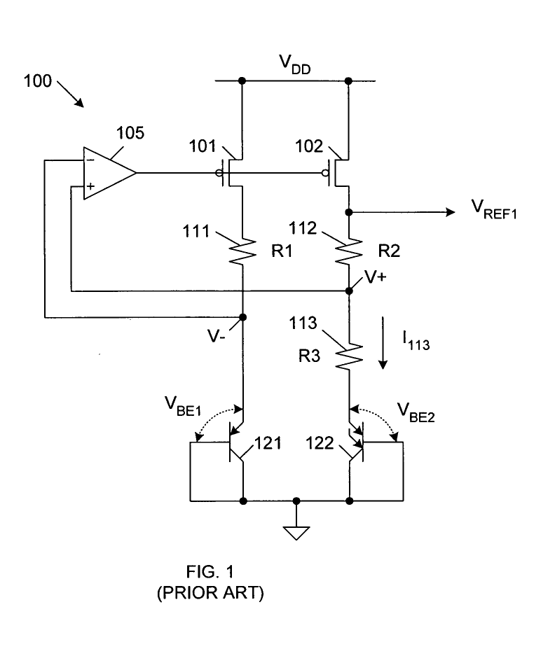

FIG. 2 is a circuit diagram of another conventional bandgap voltage reference circuit.

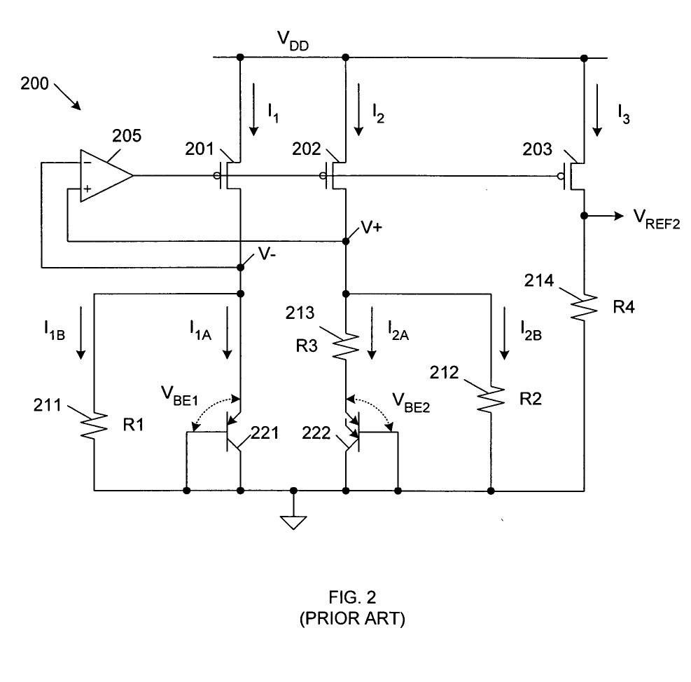

FIG. 3 is a graph that illustrates a simulated DC voltage sweep on the gates of transistors of the voltage reference circuit of FIG. 2.

FIG. 4 is a circuit diagram of an on-chip bandgap voltage and current reference circuit in accordance with one embodiment of the present invention.

FIG. 5 is a circuit diagram of an on-chip bandgap voltage and current reference circuit in accordance with another embodiment of the present invention.

FIG. 6 is a graph that illustrates a simulated DC voltage sweep on the gates of transistors of the voltage and current reference circuit of FIG. 5.

### DETAILED DESCRIPTION

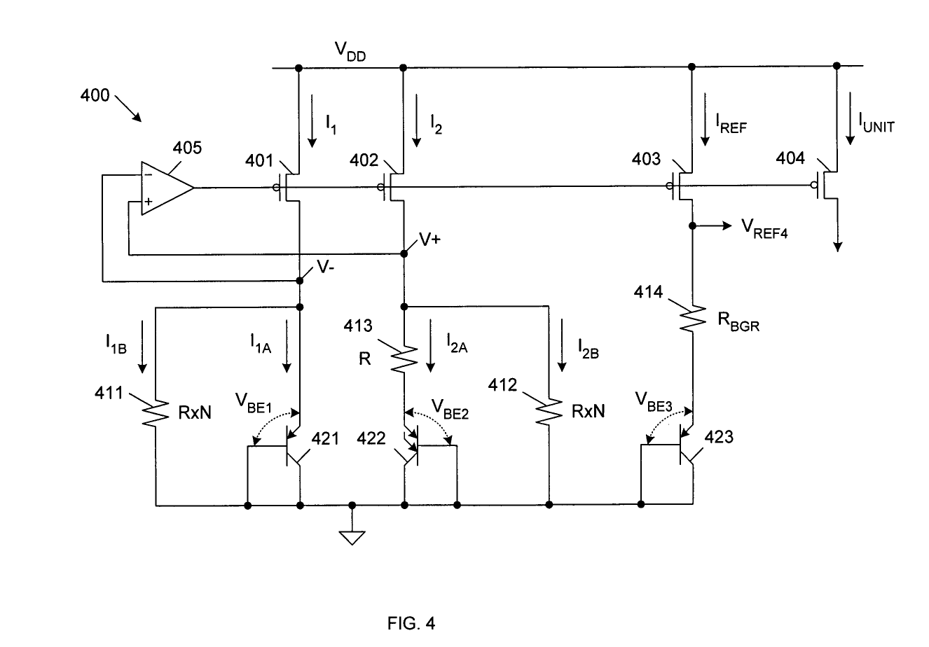

FIG. 4 is a circuit diagram of an on-chip bandgap voltage and current reference circuit 400 in accordance with one embodiment of the present invention. Voltage/current reference circuit 400 can be used, for example, in CMOS analog/mixed signal chips.

Voltage reference circuit 400 includes PMOS transistors 401-404, operational amplifier 405, resistors 411-414 and PNP bipolar transistors 421-423. The dimensions of PMOS transistors 401-404 are the same. The sources of PMOS transistors 401-404 are coupled to the V_{DD} voltage supply terminal. The drains of PMOS transistors 401 and 402 are coupled to the “−” and “+” input terminals of operational amplifier 405. The input voltages to the “−” and “+” input terminals of operational amplifier 405 are labeled as input voltages V− and V+, respectively. The output terminal of operational amplifier 405 is coupled to the gates of PMOS transistors 401-404. The currents through PMOS transistors 401, 402, 403 and 404 are designated as I₁, I₂, I_{REF}, and I_{UNIT}, respectively. These currents are all equal to one another.
I₁=I₂=I_{REF}=I_{UNIT} (12)

Resistor 411 and PNP bipolar transistor 421 are coupled in parallel between the drain of PMOS transistor 401 and the V_{SS} (ground) voltage supply terminal. The base of PNP bipolar transistor 421 is also coupled to the V_{SS} voltage supply terminal. The base-to-emitter voltage of bipolar transistor 421 is designated as voltage V_{BE1}. The input voltage V− is therefore equal to V_{BE1}. Operational amplifier 405 forces the input voltages V− and V+ to be equal, such that the input voltage V+ on the drain of PMOS transistor 402 is also equal to V_{BE1}. The currents through PNP bipolar transistor 421 and resistor 411 are designated as current I_{1A} and current I_{1B}, respectively. Note that currents I₁, I_{1A} and I_{1B} exhibit the following relationship.
I₁=I_{1A}+I_{1B} (13)

Resistor 412 and the series combination of resistor 413 and PNP bipolar transistor 422 are coupled in parallel between the drain of PMOS transistor 402 and the V_{SS} voltage supply terminal. The base of PNP bipolar transistor 422 is also coupled to the V_{SS} voltage supply terminal. The base-to-emitter voltage of bipolar transistor 422 is designated as voltage V_{BE2}. The current through resistor 413 and PNP bipolar transistor 422 is designated as current I_{2A}. The current through resistor 412 is designated as current I_{2B}. Note that currents I₂, I_{2A} and I_{2B} exhibit the following relationship.
I₂=I_{2A}+I_{2B} (14)

Resistor 413 has a resistance of R, and resistors 411 and 412 each have a resistance of (R×N), where N is an integer.

Resistor 414 and PNP bipolar transistor 423 are coupled in series between the drain of PMOS transistor 403 and the V_{SS} voltage supply terminal. The base of PNP bipolar transistor 423 is also coupled to the V_{SS} voltage supply terminal. The base-to-emitter voltage of bipolar transistor 423 is designated as voltage V_{BE3}. Resistor 414 is a bandgap reference resistor that has a resistance designated R_{BGR} and configured to provide the reference voltage V_{REF4}. The drain of PMOS transistor 403 is connected to resistor 414.

Reference circuit 400 operates as follows. As described above, operational amplifier 405 forces the voltages V+ and V− to be the same (i.e., V_{BE1}). The current I_{1B} through resistor 411 and the current I_{2B} through resistor 412 can therefore be defined as follows.
I_{1B}=I_{2B}=V_{BE1}/(R×N) (15)

Combining Equations (12), (13), (14) and (15) provides the following current relationship.
I_{1A}=I_{2A} (16)

The voltage across resistor 413, designated as ΔV_{BE}, can be defined as follows.
ΔV_{BE}=V+−V_{BE2}=V_{BE1}−V_{BE2} (17)

The current I_{2A} through resistor 413 can therefore be defined as follows.
I_{2A}=ΔV_{BE}/R (18)

From Equations (14), (15) and (18), the current I₂ can be defined as follows.
I₂=ΔV_{BE}/R+V_{BE1}/(R×N) (19)

The term ΔV_{BE} has a positive temperature coefficient, the term V_{BE1} has a negative temperature coefficient and the resistance R has a positive temperature coefficient. As a result, the temperature variation of current I₂ can be compensated by the resistor ratio N. The current I₂ is mirrored to PMOS transistor 404 as the reference current I_{UNIT}. Thus, PMOS transistor 404 directly provides the desired reference current I_{UNIT}, which is insensitive to variations in temperature. Note that the resistor ratio N is selected to compensate the temperature variation of the current, not the voltage. As a result, the current reference I_{UNIT} can be generated directly.

Circuit 400 also enables a reference voltage V_{REF4} to be generated. The reference voltage V_{REF4} can be defined as follows.
V_{REF4}=V_{BE3}+I_{REF}×R_{BGR} (20)
Because the current I_{REF} is equal to the current I₂, equation (20) can be rewritten as follows.

$$\begin{matrix}{V}_{REF4} = {V}_{BE3} + [ Δ {V}_{BE} / R + {V}_{BE1} / ( R \times N ) ] \times {R}_{BGR} & ( 21 ) \\ {V}_{REF4} = {V}_{BE3} + {R}_{BGR} \times Δ {V}_{BE} / R + {R}_{BGR} \times {V}_{BE1} / ( R \times N ) & ( 22 )\end{matrix}$$

Because ΔV_{BE} has a negative temperature coefficient and R_{BGR} has a positive temperature coefficient, the reference voltage V_{REF4} can be independent of temperature when the resistor ratio N is properly selected. Moreover, the reference voltage V_{REF4} is determined by the resistance ratio R_{GBR}/R, which is not significantly influenced by the absolute value of the resistances. In the foregoing manner, PNP bipolar transistor 423 and bandgap reference resistor 414 enable the generation of a voltage reference V_{REF4} that is insensitive to temperature variation.

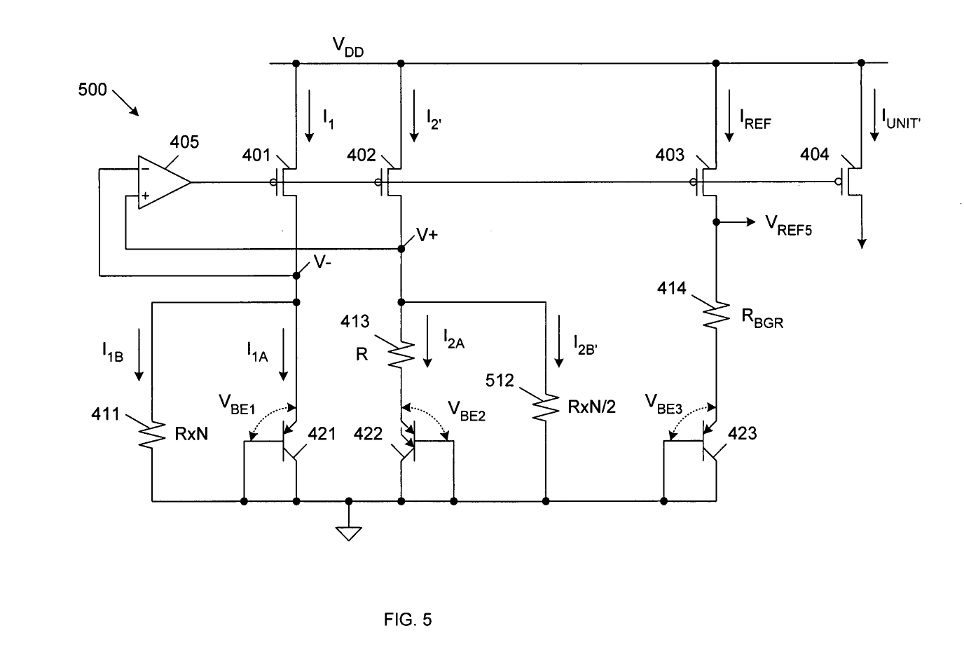

FIG. 5 is a circuit diagram of an on-chip bandgap voltage and current reference circuit 500 in accordance with another embodiment of the present invention. Voltage and current reference circuit 500 can be used, for example, in CMOS analog/mixed signal chips.

Because voltage and current reference circuit 500 (FIG. 5) is similar to voltage and current reference circuit 400 (FIG. 4), similar elements in FIGS. 4 and 5 are labeled with similar reference numbers. Thus, voltage and current reference circuit 500 includes PMOS transistors 401-404, operational amplifier 405, resistors 411 and 413-414 and PNP bipolar transistors 421-423, which have been described above in connection with FIG. 4. In addition, voltage-reference circuit 500 includes resistor 512, which replaces resistor 412 of voltage-current reference circuit 400. Resistor 512 has a resistance equal to (R×N/2). Thus, resistor 512 has a resistance equal to half of the resistance of resistor 412. As described in more detail below, this helps to ensure that reference circuit 500 only has one steady-state operating condition.

Reference circuit 500 operates in a manner similar to reference circuit 400, with the differences noted below. As described above, operational amplifier 405 forces the voltages V+ and V− to be the same (i.e., V_{BE1}). The current I_{2B′} through resistor 512 can therefore be defined as follows.
I_{2B′}=2×V_{BE1}/(R×N) (23)
The current I_{2A} through resistor 413 can be defined as follows. (See, Equation (18) above)
I_{2A}=ΔV_{BE}/R (24)

From equations (23) and (24), the current I_{2′} through PMOS transistor 402 can be defined as follows.
I_{2′}=ΔV_{BE}/R+2×V_{BE1}/(R×N) (25)

The current I_{2′} is reflected to transistor 404 as the reference current I_{UNIT′}. The term ΔV_{BE} has a positive temperature coefficient, and the term V_{BE1} has a negative temperature coefficient and the resistance R has a positive temperature coefficient. As a result, the temperature variation of current I_{UNIT′} can be compensated by the resistor ratio N. Thus, current I_{UNIT′} is insensitive to variations in temperature. Note that the resistor ratio N is selected to compensate the temperature variation of the current, not the voltage. As a result, the current reference I_{UNIT′} can be generated directly.

Circuit 500 also enables a reference voltage V_{REF5} to be generated. The reference voltage V_{REF5} can be defined as follows.
V_{REF5}=V_{BE3}+I_{REF′}×R_{BGR} (26)
Because the current I_{REF′} is equal to the current I_{2′}, equation (26) can be rewritten as follows.
V_{REF5}=V_{BE3}+[ΔV_{BE}/R+2×V_{BE1}/(R×N)]×R_{BGR} (27)
V_{REF5}=V_{BE3}+R_{BGR}×ΔV_{BE}/R+2R_{BGRx}×V_{BE1}/(R×N) (28)

Because ΔV_{BE} has a negative temperature coefficient and R_{BGR} has a positive temperature coefficient, the reference voltage V_{REF5} can be independent of temperature when the resistor ratio N is properly selected. Moreover, the reference voltage V_{REF5} is determined by the resistance ratio R_{GBR}/R, which is not significantly influenced by the absolute value of the resistances. In the foregoing manner, PNP bipolar transistor 423 and bandgap reference resistor 414 enable the generation of a voltage reference V_{REF5} that is insensitive to temperature variation.

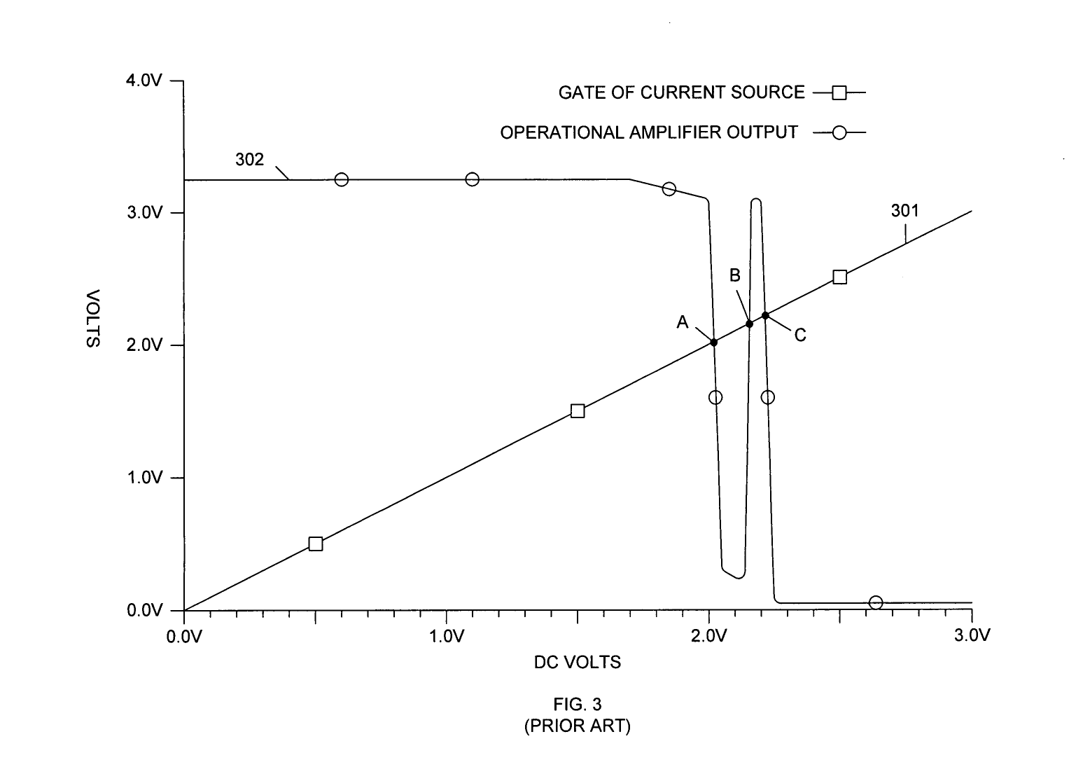

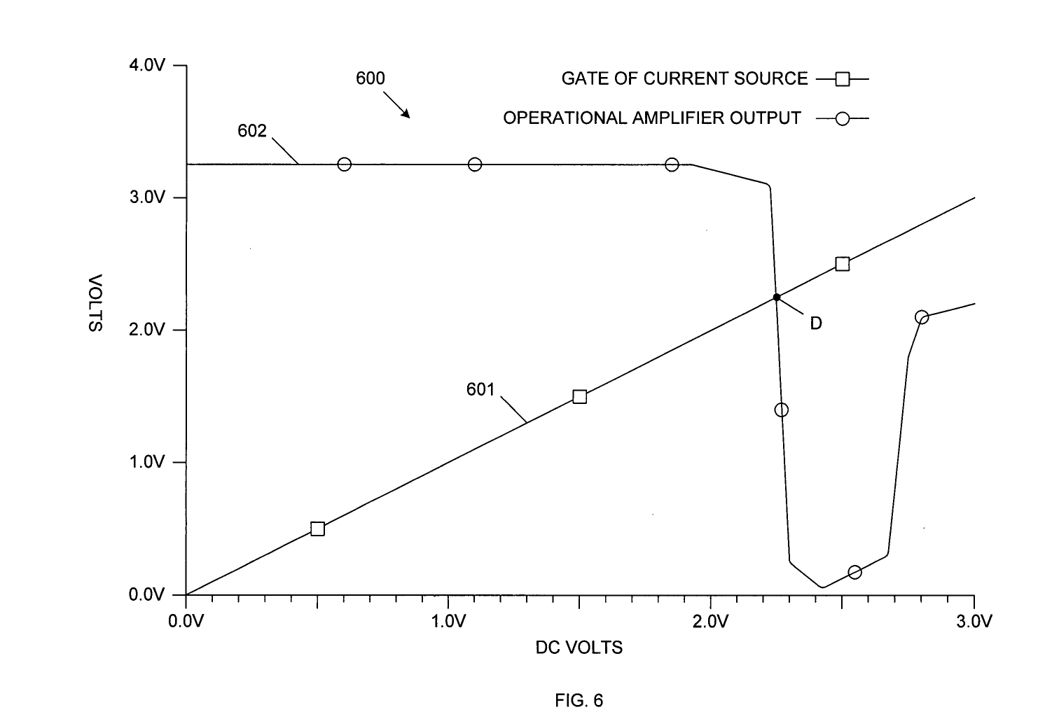

FIG. 6 is a graph 600 that illustrates a simulated DC voltage sweep from 0 Volts to 3 Volts on the gates of transistors 401-404 (line 601), and the resultant output voltage of operational amplifier 405 (line 602). In this simulation, the output terminal of operational amplifier 405 is disconnected from the gates of PMOS transistors 401-404. Graph 600 illustrates that there is one cross-points, D, where the output of operational amplifier 405 is equal to the voltage applied to the gates of transistors 401-404. Thus, there is only one possible steady state operating condition for reference circuit 500, thereby ensuring that this circuit ends up in the desired operating state. In this manner, resistor 512 avoids the start-up problem illustrated in FIG. 3, such that the reference circuit 500 only has one steady state condition.

In the foregoing manner, the reference circuits 400 and 500 provide both current and voltage references. Both are insensitive to the variations of temperature and power supply. The typical variation of such a circuit is less than +/−10%, which is limited by the process variation. This is an improvement over the prior art reference circuits 100 and 200, which exhibit a +/−30% variation in associated reference currents.

Although the invention has been described in connection with several embodiments, it is understood that this invention is not limited to the embodiments disclosed, but is capable of various modifications, which would be apparent to a person skilled in the art. Thus, the invention is limited only by the following claims.

1. A current reference circuit comprising:
a first bipolar transistor that exhibits a first voltage drop V_{BE1};
a second bipolar transistor that exhibits a second voltage drop V_{BE2};
a first resistor having a resistance R1, the first resistor being configured to draw a first current proportional to (V_{BE1}−V_{BE2})/R1;
a second resistor having a resistance R2, the second resistor being configured to draw a second current proportional to V_{BE1}/R2;
a first transistor configured to supply the first and second currents; and
a second transistor configured in a current mirror circuit with the first transistor, wherein the second transistor provides a reference current proportional to (V_{BE1}−V_{BE2})/R1+V_{BE1}/R2.

2. The current reference of claim 1, further comprising:
a third transistor configured in a current mirror configuration with the first transistor, wherein the third transistor provides a reference current proportional to (V_{BE1}−V_{BE2})/R1+V_{BE1}/R2;
a third resistor having a resistance R3; and
a third bipolar transistor that exhibits a third voltage drop V_{BE3}, wherein the third resistor and the third bipolar transistor are connected in series with the third transistor, such that a voltage drop proportional to V_{BE3}+R3[(V_{BE1}−V_{BE2})/R1+V_{BE1}/R2] exists across the third resistor and the third bipolar transistor.

3. The current reference of claim 1, wherein the resistance R1 is greater than the resistance R2.

4. The current reference of claim 1, wherein the first voltage drop V_{BE1} is greater than the second voltage drop V_{BE2}.

5. The current reference of claim 1, wherein the first bipolar transistor and the second bipolar transistor are PNP bipolar transistors.

6. The current reference of claim 1, wherein the first and second transistors are p-channel MOS transistors.

7. The current reference of claim 1, further comprising:
a third resistor having a resistance R3 and being coupled in parallel with the first bipolar transistor, the third resistor being configured to draw a third current proportional to V_{BE1}/R3;
a third transistor configured to supply current to the third resistor and the first bipolar transistor; and
an operational amplifier having input terminals coupled to drains of the first and third transistors, and an output terminal coupled to gates of the first, second and third transistors.

8. The current reference of claim 7, wherein the second resistance R2 is equal to the third resistance R3.

9. The current reference of claim 8, wherein the first resistance R1 is less than the second resistance R2 and the third resistance R3.

10. The current reference of claim 7, wherein the second resistance R2 is less than the third resistance R3.

11. A current reference circuit comprising:
an operational amplifier having a first input terminal, a second input terminal and an output terminal;
a first transistor having a source coupled to a first voltage supply terminal, a gate coupled to the output terminal of the operational amplifier and a drain coupled to the first input terminal of the operational amplifier;
a second transistor having a source coupled to the first voltage supply terminal, a gate coupled to the output terminal of the operational amplifier, and a drain coupled to the second input terminal of the operational amplifier;
a first resistor coupled between the drain of the first transistor and a second voltage supply terminal;
a first bipolar transistor coupled between the drain of the first transistor and the second voltage supply terminal, wherein a base of the first bipolar transistor is coupled to the second voltage supply terminal;
a second resistor coupled between the drain of the second transistor and the second voltage supply terminal;
a third resistor coupled to the drain of the second transistor;
a second bipolar transistor, coupled in series between the third resistor and the second voltage supply terminal, the second bipolar transistor having a base coupled to the second voltage supply terminal; and
a third transistor having a source coupled to the first voltage supply terminal, a gate coupled to the output terminal of the operational amplifier and a drain configured to provide a reference current.

12. The current reference circuit of claim 11, further comprising:
a fourth transistor having a source coupled to the first voltage supply terminal, a gate coupled to the output terminal of the operational amplifier and a drain;
a fourth resistor coupled to the drain of the fourth transistor and configured to provide a reference voltage; and
a third bipolar transistor, wherein the fourth resistor and the third bipolar transistor are coupled in series between the drain of the fourth transistor and the second voltage supply terminal, the third bipolar transistor having a base coupled to the second voltage supply terminal.

13. The current reference circuit of claim 12, wherein the resistance of the first resistor is N times greater than the resistance of the third resistor.

14. The current reference circuit of claim 13, wherein the resistance of the second resistor is equal to the resistance of the first resistor.

15. The current reference circuit of claim 13, wherein the resistance of the second resistor is less than the resistance of the first resistor.

16. The current reference circuit of claim 11, wherein the first bipolar transistor exhibits a base-to-emitter voltage that is larger than a base-to-emitter voltage of the second bipolar transistor.

17. A method of generating a reference current, the method comprising:
generating a first current that is proportional to the difference between the base-to-emitter voltage of a first bipolar transistor and the base-to-emitter voltage of a second bipolar transistor;
generating a second current that is proportional to the base-to-emitter voltage of the first bipolar transistor; and
generating a reference current equal to the sum of the first current and the second current.

18. A method of generating a reference current, the method comprising:
applying a first voltage representative of a base-to-emitter voltage of a first bipolar transistor across a first resistor, thereby creating a first current;
applying a second voltage across a second resistor, thereby creating a second current, wherein the second voltage is representative of a difference between the first voltage and a third voltage representative of a base-to-emitter voltage of a second bipolar transistor;
providing a reference current equal to the sum of the first current and the second current.

19. The method of claim 18, wherein the step of providing the reference current comprises:
supplying the first current and the second current through a first MOS transistor; and
mirroring the current through the first MOS transistor to a second MOS transistor.

20. The method of claim 18, further comprising:
providing a third current equal to the reference current through a third resistor, thereby creating a voltage drop across the fourth resistor; and
adding the voltage drop to a fourth voltage representative of a base-to-emitter voltage of a third bipolar transistor, thereby creating a reference voltage.
